(19) United States
(12) Patent Application Publication
(10) Pub. No.: US 2020/0198377 A1
(43) Pub. Date: Jun. 25, 2020

(54) METHOD OF ADJUSTING SENSOR OUTPUT AND PRINTER

(71) Applicant: BROTHER KOGYO KABUSHIKI KAISHA, Nagoya-shi (JP)

(72) Inventors: Yuki Hiramatsu, Nukata-gun (JP); Norio Fujimura, Toyokawa-shi (JP)

(21) Appl. No.: 16/714,673

(22) Filed: Dec. 13, 2019

(30) Foreign Application Priority Data
Dec. 21, 2018 (JP) 2018-239306

(51) Int. Cl. B41J 11/42; B41J 3/407; B41J 29/38; B41J 11/00; G06K 19/06

(52) U.S. Cl. CPC B41J 11/42; B41J 3/4075; G06K 19/06028; B41J 11/008; B41J 29/38

(57) ABSTRACT

A method of adjusting an output of a sensor in a printer, the sensor being configured to detect a detection target that is one of a medium itself and a mark attached to the medium, the method including: a first determining step of determining a correction value corresponding to an output characteristic unique to the sensor; a recording step of recording, on a record carrier, adjustment information that is based on the determined correction value, such that the adjustment information is associated with a specific sensor that is the sensor for which the correction value is determined; an acquiring step of acquiring, from the record carrier, the adjustment information associated with the specific sensor; and an adjusting step of adjusting, in the printer on which the specific sensor is installed, an output of the specific sensor based on the acquired adjustment information.

### CROSS REFERENCE TO RELATED APPLICATION

The present application claims priority from Japanese Patent Application No. 2018-239306, which was filed on Dec. 21, 2018, the disclosure of which is herein incorporated by reference in its entirety.

### BACKGROUND

### Technical Field

The following disclosure relates to a method of adjusting a sensor output and also relates to a printer.

### Description of Related Art

A printer configured to perform printing on a long-length printing medium is conventionally known. For instance, a known printer uses, as a printing medium, a printing tape in the form of a roll. A plurality of identification marks are printed beforehand on the printing tape so as to be arranged in one row and spaced at predetermined intervals in the length direction of the printing tape. The printer includes an optical sensor having a light emitting portion and a light receiving portion. When the printing tape is conveyed, the light emitting portion emits light toward the printing tape and the light receiving portion receives light reflected from the printing tape. The optical sensor produces an output corresponding to an amount of the light received by the light receiving portion. The printer reads the identification marks based on the output from the optical sensor. The printer determines a type of the printing tape and a remaining amount of the printing tape based on the read identification marks.

### SUMMARY

The luminance of light emitted from the light emitting portion (the luminance of the light emitting portion) and the light-receiving sensitivity of the light receiving portion may vary from one optical sensor to another in manufacture. Further, due to slack of the printing tape, for instance, the printing tape being conveyed may shift or move in a direction in which the printing tape is opposed to the optical sensor with respect to a designed position to which the printing tape should be conveyed. This causes a change in a distance between the optical sensor and the printing tape, i.e., a detecting distance. Due to each of or a combination of those factors, even when the same identification marks are detected in the individual printers, the output of the optical sensor may vary one printer to another. The variation in the output among the optical sensors may cause a reduction in the accuracy of detection of the identification marks by the optical sensors, resulting in a possibility of erroneous determination of the type of the printing tape and the remaining amount of the printing tape. Further, in the case where the position of the printing tape is identified, the position of the printing tape may be erroneously identified.

Accordingly, one aspect of the present disclosure is directed to a method of adjusting an output of a sensor, which method is capable of improving detection accuracy of the sensor. Another aspect of the present disclosure is directed to a printer capable of improving detection accuracy of the sensor.

In a first aspect of the present disclosure, a method of adjusting an output of a sensor in a printer configured to detect a detection target that is one of a medium itself and a mark attached to the medium includes: a first determining step of determining a correction value corresponding to an output characteristic unique to the sensor; a recording step of recording, on a record carrier, adjustment information that is based on the correction value determined in the first determining step, such that the adjustment information is associated with a specific sensor that is the sensor for which the correction value is determined in the first determining step; an acquiring step of acquiring, from the record carrier, the adjustment information associated with the specific sensor; and an adjusting step of adjusting, in the printer on which the specific sensor is installed, an output of the specific sensor based on the adjustment information acquired in the acquiring step.

In a second aspect of the present disclosure, a printer includes: a sensor configured to detect a detection target that is one of a medium itself and a mark attached to the medium; an acquirer configured to acquire, from a record carrier, adjustment information that is based on a correction value corresponding to an output characteristic unique to the sensor; and an adjuster configured to adjust an output of the sensor based on the adjustment information acquired by the acquirer.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a perspective view of a printer according to one embodiment in a state in which a cover is opened, the view seen from a front right upper side of the printer;

FIG. 2 is a cross-sectional view of the printer taken along a plane orthogonal to a right-left direction, the view illustrating a state of the printer in which the cover is closed;

FIG. 3 is a block diagram illustrating an electrical configuration of the printer;

FIG. 4 is a flowchart indicating a method of adjusting a sensor output;

FIG. 5 is a view for explaining a measuring step;

FIG. 6 is a graph indicating measurement results of an output voltage of an optical sensor with respect to a detecting distance in the measuring step;

FIG. 7 is a flowchart indicating a sensor-output adjusting processing;

FIG. 8 is a graph indicating measurement results of a relative output voltage of the optical sensor after having been adjusted according to a comparative example with respect to the detecting distance; and

FIG. 9 is a graph indicating measurement results of a relative output voltage of the optical sensor after having adjusted according to the embodiment with respect to the detecting distance.

### DETAILED DESCRIPTION OF THE EMBODIMENT

Hereinafter, there will be described one embodiment with reference to the drawings. The drawings are for explaining technical features employable in the present disclosure. It is to be understood that the configuration of a device, flowcharts of various processings, etc., illustrated in the drawings do not limit the present disclosure but are only explanatory examples.

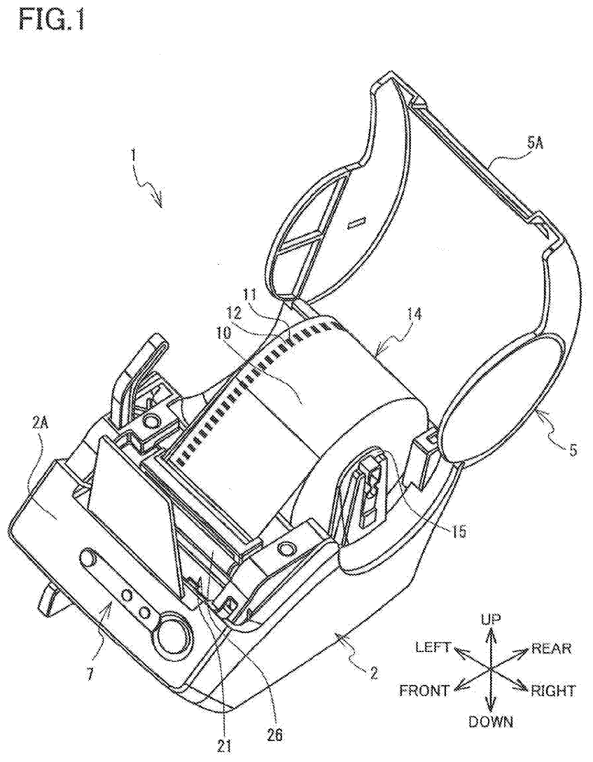

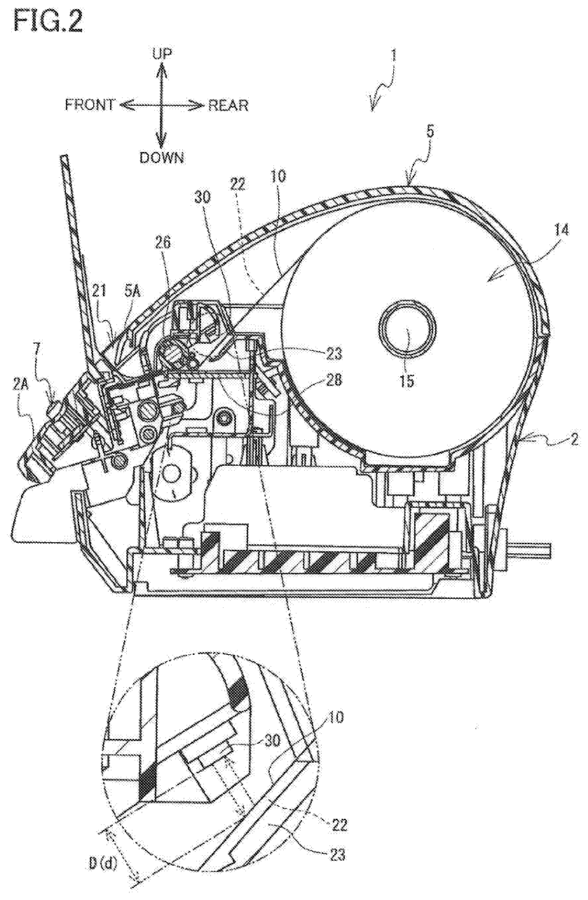

Referring to FIGS. 1 and 2, there will be explained an overall structure of a printer 1 according to one embodiment. In the following description, the upper right side, the lower left side, the lower right side, the upper left side, the upper side, and the lower side in FIG. 1 are defined respectively as the rear side, the front side, the right side, the left side, the upper side, and the lower side of the printer 1.

The printer 1 shown in FIG. 1 is configured to print, on a printing tape 10, letters, numerals, symbols, figures, and the like. The printer 1 includes a housing 2 and a cover 5. The cover 5 is disposed above the housing 2 so as to be openable and closable relative to the housing 2. An operation portion 7 is provided on a front surface 2A of the housing 2. The operation portion 7 includes a power button, etc., and various sorts of information can be input to the printer 1 through the operation portion 7.

As shown in FIG. 2, a tape roll 14 is removably contained in a rear portion of the housing 2. The tape roll 14 is formed by winding the printing tape 10 around a core 15. The tape roll 14 is rotatable. In a state in which the cover 5 is closed, a discharge opening 21 is defined between a front end 5A of the cover 5 and the front surface 2A of the housing 2. A thermal head 28 is disposed behind the discharge opening 21. A platen roller 26 is disposed above the thermal head 28. An optical sensor 30 for detecting identification marks 11 (FIG. 1) is disposed obliquely upward of the platen roller 26 on the rear side of the platen roller 26. The optical sensor 30 is located above the printing tape 10 being conveyed so as to be opposed to the printing tape 10 with a spacing interposed therebetween. The spacing will be referred to as a detecting distance d.

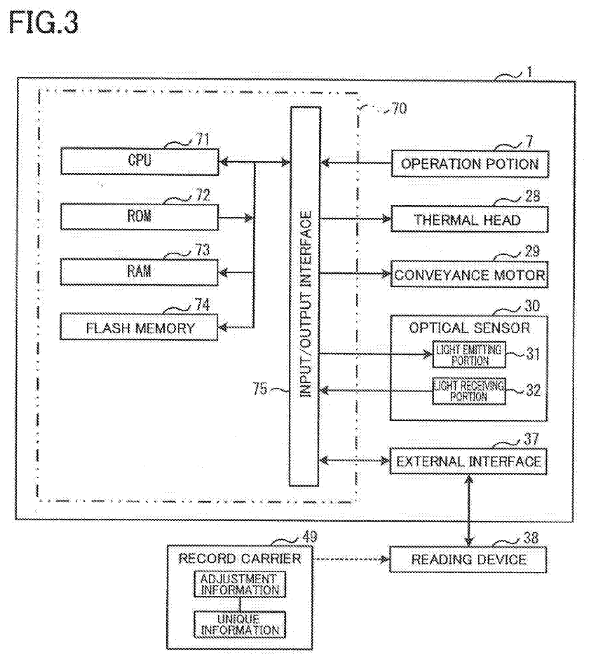

The platen roller 26 is opposed to the thermal head 28 and is movable in the up-down direction in conjunction with the opening and closing movement of the cover 5. In the state in which the cover 5 is closed, the platen roller 26 cooperates with the thermal head 28 to nip the printing tape 10 therebetween. In a state in which the cover 5 is open, the platen roller 26 is located away upward from the thermal head 28. The platen roller 26 is rotated by a drive force of a conveyance motor 29 (FIG. 3) in the state in which the cover 5 is closed, so that the printing tape 10 drawn from the tape roll 14 is conveyed toward the discharge opening 21 along a conveyance path 22. The conveyance path 22 is defined by a support member 23, etc. The thermal head 28 performs printing on the printing tape 10 conveyed by the platen roller 26.

Various types of the printing tape 10 are usable in the printer 1. The type of the printing tape 10 includes a width, a color, a material, etc., of the tape. Further, the type of the printing tape 10 includes a die cut tape in which print labels are arranged in its longitudinal direction so as to be spaced at predetermined intervals, a multi-layered tape including an adhesive agent between a long-length print label and release paper, a single-layer tape without an adhesive agent, and a long-length tube tape.

As shown in FIG. 1, the identification marks 11 are printed on the printing tape 10 beforehand. The identification marks 11 are arranged in a longitudinal direction of the printing tape 10 so as to be spaced at predetermined intervals. There are formed mark-non-printed portions 12 each of which is located between corresponding adjacent two of the identification marks 11. The mark-non-printed portions 12 are a part of the printing tape 10. The identification marks 11 have reflectivity different from that of the mark-non-printed portions 12. In the present embodiment, the reflectivity of the identification marks 11 is lower than the reflectivity of the mark-non-printed portions 12. It is noted that the reflectivity of the identification marks 11 and the reflectivity of the mark-non-printed portions 12 differ depending on the type of the printing tape 10.

Referring to FIG. 3, there will be explained an electrical configuration of the printer 1. The printer 1 includes a control board 70. There are provided, on the control board 70, a CPU 71, a ROM 72, a RAM 73, a flash memory 74, and an input/output interface 75 so as to be connected to one another. The CPU 71 controls the printer 1. The ROM 72 stores parameters or the like required when the CPU 71 executes various programs. The RAM 73 temporarily stores various sorts of information such as computing results by the CPU 71. The flash memory 74 stores various programs executed by the CPU 71. Various programs include an adjustment program for executing an adjusting processing explained later.

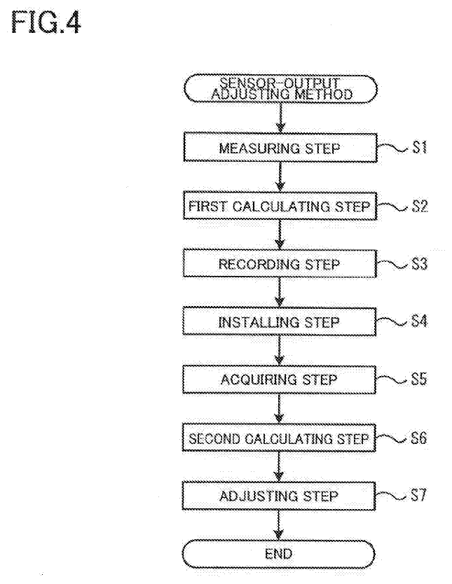

To the input/output interface 75, the operation portion 7, the thermal head 28, the conveyance motor 29, the optical sensor 30, an external interface 37 are connected. To the external interface 37, a reading device 38 is connectable, for instance. The reading device 38 is connected to the external interface 37 in an acquiring step (S5 of FIG. 4) that will be later explained, so as to read information from a record carrier 49 that will be later explained.

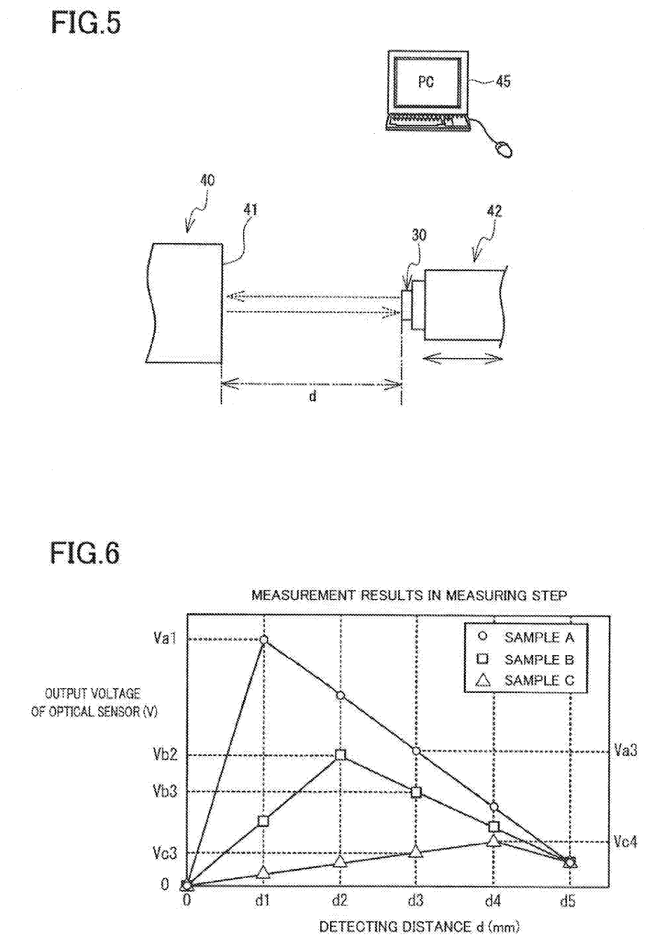

The optical sensor 30 is of a reflective type and includes a light emitting portion 31 as a light emitter and a light receiving portion 32 as a light receiver. The CPU 71 controls the optical sensor 30 such that light is emitted from the light emitting portion 31 in a predetermined amount. The light emitted from the light emitting portion 31 travels toward the printing tape 10, is then reflected by the printing tape 10, and finally travels toward the light receiving portion 32. (See FIG. 2.) In an enlarged view of FIG. 2, the travelling light is schematically indicated by arrows in the dashed line. (Similarly, the travelling light is indicated by arrows in the dashed line in FIG. 5.) The light receiving portion 32 receives light reflected by the identification mark 11 or light reflected by the mark-non-printed portion 12. The optical sensor 30 outputs, to the CPU 71, a voltage corresponding to an amount of the light received by the light receiving portion 32.

The CPU 71 reads the identification mark 11 (FIG. 1) based on the output voltage of the optical sensor 30. Specifically, the CPU 71 determines that the identification mark 11 is detected when the output voltage of the optical sensor 30 falls within a mark detecting range. On the other hand, the CPU 71 determines that the mark-non-printed portion 12 is detected when the output voltage of the optical sensor 30 falls within a mark-non-printed-portion detecting range. In the present embodiment, a lower limit of the mark-non-printed-portion detecting range is higher than an upper limit of the mark detecting range. The mark detecting range and the mark-non-printed-portion detecting range are stored in the ROM 72.

The CPU 71 makes various determinations based on the detected identification marks 11. The ROM 72 stores a table (not shown) in which the type of the identification marks 11 and the type of the printing tape 10 are associated with each other. Referring to this table, the CPU 71 can identify the type of the printing tape 10 based on the detected identification marks 11. Further, the CPU 71 can identify an unused amount of the printing tape 10, i.e., a remaining amount of the printing tape 10, by counting the number of the detected identification marks 11, for instance. Moreover, the CPU 71 can detect the position of the printing tape 10 based on the positions of the detected identification marks 11.

Referring to FIGS. 4-7, there will be explained a sensor-output adjusting method for adjusting the output voltage of the optical sensor 30. As shown in FIG. 4, the sensor-output adjusting method includes a measuring step (S1), a first calculating step (S2), a recording step (S3), an installing step (S4), an acquiring step (S5), a second calculating step (S6), and an adjusting step (S7) that are performed in the order of description. In the installing step (S4), the optical sensor 30 is incorporated in the housing 2. In other words, the measuring step (S1), the first calculating step (S2), and the recording step (S3) are performed on the optical sensor 30 alone, that is, those steps are performed in a state in which the optical sensor 30 is not incorporated in the housing 2. On the other hand, the acquiring step (S5), the second calculating step (S6), and the adjusting step (S7) are performed in a state in which the optical sensor 30 is incorporated in the housing 2. The steps will be hereinafter explained in detail.

As shown in FIG. 5, in the measuring step (S1 of FIG. 4), a reference subject 40 and a jig 42 are used. The reference subject 40 has a reference surface 41. The reflectivity of the reference surface 41 is a predetermined constant value. The jig 42 is opposed to the reference surface 41 and movable to at least two positions in a direction in which the jig 42 is opposed to the reference surface 41. The optical sensor 30 is mounted on the jig 42. The optical sensor 30 is connected to a personal computer (hereinafter referred to as “PC 45”), for instance. In the measuring step, the detecting distance d is a distance between the reference surface 41 and the optical sensor 30 mounted on the jig 42. The jig 42 is movable toward and away from the reference surface 41, and the output voltage of the optical sensor 30 is measured at each of a plurality of the detecting distances d. Specifically, at each of the detecting distances d, the PC 45 controls the optical sensor 30 mounted on the jig 42 such that the light emitting portion 31 emits light toward the reference surface 41. The light receiving portion 32 receives light reflected by the reference surface 41. The optical sensor 30 outputs, to the PC 45, a voltage corresponding to the amount of the light received by the light receiving portion 32. Thus, the output voltage of the optical sensor 30 is measured at each of the detecting distances d. Hereinafter, the value indicative of the voltage measured at each detecting distance d in the measuring step will be referred to as “measurement value”. The measurement value changes with a change in the detecting distance d. Specifically, the measurement value increases with an increase in the detecting distance d up to a specific detecting distance d and, after peaking at the specific detecting distance d, the measurement value decreases with an increase in the detecting distance d beyond the specific detecting distance d.

FIG. 6 is a graph indicating a relationship between the detecting distance d and the output voltage of the optical sensor 30. Specifically, the graph shows the measurement results obtained in the measuring step for three samples of the optical sensor 30. The three samples are a sample optical sensor A, a sample optical sensor B, and a sample optical sensor C. In the graph of FIG. 6, the measurement results of the sample optical sensor A are indicated by circular marks, the measurement results of the sample optical sensor B are indicated by square marks, and the measurement results of the sample optical sensor C are indicated by triangular marks. The optical sensors 30 suffer from manufacturing variations. In other words, the luminance (the light emission amount) of the light emitting portion 31 and the light-receiving sensitivity of the light receiving portion 32 may vary one optical sensor 30 to another. Thus, due to the variations, the output characteristic with respect to the detecting distance d differs among the optical sensors 30. In the sample optical sensor A, the luminance of the light emitting portion 31 is high (i.e., the light emission amount is large) and the light-receiving sensitivity of the light receiving portion 32 is high. In the sample optical sensor C, the luminance of the light emitting portion 31 is low (i.e., the light emission amount is small) and the light-receiving sensitivity of the light receiving portion 32 is low. In the sample optical sensor B, the luminance of the light emitting portion 31 is average (i.e., the light emission amount is average) and the light-receiving sensitivity of the light receiving portion 32 is average. The graph of FIG. 6 indicates the measurement values at 0, d1, d2, d3, d4, and d5 each as the detecting distance d. The measurement values at the respective detecting distances 0-d5 are stored in a memory (not shown) of the PC 45, for instance.

The first calculating step (S2 of FIG. 4) is one example of a first determining step of determining a correction value corresponding to an output characteristic unique to the optical sensor 30. In the first calculating step, the correction value corresponding to the output characteristic unique to the optical sensor 30 is calculated. Specifically, a peak value and a reference value are identified based on the measurement values. The peak value indicates a peak of the output voltage of the optical sensor 30. The reference value indicates the output voltage of the optical sensor 30 at a reference detecting distance D (FIG. 2). As shown in FIG. 2, the reference detecting distance D is a distance between the optical sensor 30 installed on the printer 1 and the printing tape 10 on the conveyance path 22. Specifically, the reference detecting distance D is a distance between: the optical sensor 30 installed on the printer 1; and a point of intersection of the light emitted from the light emitting portion 31 and the conveyance path 22 in design. In the present embodiment, the reference detecting distance D is equal to the detecting distance d3. The correction value is calculated based on the identified peak value and reference value. The correction value is a ratio of the reference value to the peak value.

As shown in FIG. 6, the measurement values of each of the sample optical sensors A-C are connected by line segments in order starting from the value at the smallest detecting distance d, so as to estimate the peak value and the reference value. Specifically, the peak value is Val and the reference value is Va3 in the sample optical sensor A, the peak value is Vb2 and the reference value is Vb3 in the sample optical sensor B, and the peak value is Vc4 and the reference value is Vc3 in the sample optical sensor C. Further, the correction value in the sample optical sensor A is Va3/Val, the correction value in the sample optical sensor B is Vb3/Vb2, and the correction value in the sample optical sensor C is Vc3/Vc4.

In the present embodiment, the first calculating step is implemented as the first determining step. In place of the first calculating step, there may be implemented, as the first determining step, a step of determining the correction value by referring to a table or the like, for instance.

In the recording step (S3 of FIG. 4), the adjustment information indicative of the correction value calculated in the first calculating step (S2 of FIG. 4) is recorded on the record carrier 49 so as to be associated with unique information. The unique information indicates the optical sensor 30 for which the adjustment information is calculated in the first calculating step. In other words, the unique information is information for identifying or recognizing each of the individual optical sensors 30. The record carrier 49 is an adhesive tape on which is printed a bar code indicating the adjustment information and the unique information, for instance. The record carrier 49 is managed so as to be associated with the optical sensor 30 indicated by the unique information recorded thereon. Specifically, the record carrier 49 is stuck on a board or the like on which the optical sensor 30 is mounted.

In the installing step (S4 of FIG. 4), the optical sensor 30 is incorporated in the housing 2. In a state in which the optical sensor 30 is incorporated in the housing 2, the distance between the optical sensor 30 and the conveyance path 22 (the printing tape 10) is equal to the reference detecting distance D (the detecting distance d3) as shown in FIG. 2.

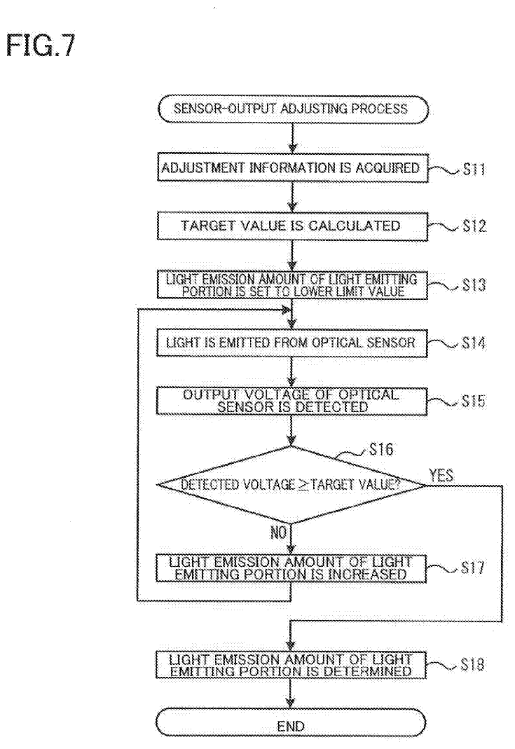

In the present embodiment, the CPU 71 of the printer 1 executes the adjusting processing (FIG. 7) according to the adjustment program to implement the acquiring step (S5), the second calculating step (S6), and the adjusting step (S7).

Referring to FIG. 7, the adjusting processing will be explained. When the printer 1 is turned on and a predetermined operation is performed, the CPU 71 reads out the adjustment program from the flash memory 74 to execute the adjusting processing. A user uses the reading device 38 to read the adjustment information from the record carrier 49 associated with the optical sensor 30. The CPU 71 acquires the adjustment information associated with the optical sensor 30 from the record carrier 49 through the reading device 38 (S11). The acquired adjustment information is stored in the RAM 73. The processing at S11 corresponds to the acquiring step (S5). The CPU 71 calculates a target value based on the correction value indicated by the acquired adjustment information (S12). The target value is the output voltage required to be output with the optical sensor 30 when the optical sensor 30 detects the identification mark 11 at the reference detecting distance D. Specifically, the target value is calculated according to the following equation (1):

Vtar=K×Vpk (1)

wherein Vtar represents the target value, Vpk represents a working-voltage upper limit value, and K represents the correction value. The processing at S12 corresponds to the second calculating step (S6).

The working-voltage upper limit value is a design value of the output voltage of the optical sensor 30 at a peak detecting distance. The working-voltage upper limit value is determined beforehand at design time and stored in the ROM 72. The peak detecting distance is the detecting distance d corresponding to the peak value identified in the first calculating step (S2). Specifically, the peak detecting distance is the detecting distance d1 in the sample optical sensor A, the detecting distance d2 in the sample optical sensor B, and the detecting distance d4 in the sample optical sensor C.

The second calculating step is one example of a second determining step of determining, based on the correction value indicated by the adjustment information acquired in the acquiring step, the target value that is the output value required to be output with the optical sensor 30 when the optical sensor 30 detects the detection target at the reference detecting distance. In the present embodiment, the second calculating step is implemented as the second determining step. In place of the second calculating step, there may be implemented, as the second determining step, a step of determining the correction value by referring to a table or the like, for instance.

The CPU 71 sets the light emission amount of the light emitting portion 31 to a lower limit value (S13). The light emission amount set at S13 is stored in the RAM 73. The CPU 71 controls the light emitting portion 31 to emit the light in the set amount (S14). The light emitted by the light emitting portion 31 is reflected by the printing tape 10. The light receiving portion 32 receives the light reflected by the printing tape 10. The optical sensor 30 outputs, to the CPU 71, the voltage corresponding to the amount of the light received by the light receiving portion 32. The CPU 71 detects the output voltage of the optical sensor 30 (S15). The output voltage of the optical sensor 30 detected in the processing at S15 will be hereinafter referred to as “detected voltage” where appropriate. The detected voltage is stored in the RAM 73.

The CPU 71 then determines whether the detected voltage is not smaller than the target value (S16). When the detected voltage is smaller than the target value (S16: NO), the CPU 71 increases, by a predetermined amount, the light emission amount of the light emitting portion 31 (S17), and the control flow returns to S14. Thereafter, in the processing at S14, the light emitting portion 31 emits the light in the amount set in the processing at S17. The CPU 71 repeats S14-S17 until the detected voltage becomes equal to or larger than the target value.

When the detected voltage becomes equal to or larger than the target value (S16: YES), the CPU 71 determines, as a light emission amount after adjustment, the light emission amount that is being currently set (S18). The determined light emission amount is stored in the flash memory 74. The CPU 71 then ends the adjusting processing. According to the processings at S13-S17, the detected voltage is adjusted so as to become equal to the target value based on the acquired adjustment information. The processings at S13-S17 correspond to the adjusting step (S7).

When the CPU 71 activates the optical sensor 30 after the adjusting processing, the CPU 71 controls the light emitting portion 31 of the optical sensor 30 to emit the light in the amount stored in the flash memory 74. The optical sensor 30 outputs the voltage corresponding to the amount of the light received by the light receiving portion 32. The CPU 71 determines whether the identification mark 11 is detected or whether the mark-non-printed portion 12 is detected depending on whether the detected output voltage of the optical sensor 30 falls in the mark detecting range or in the mark-non-printed-portion detecting range.

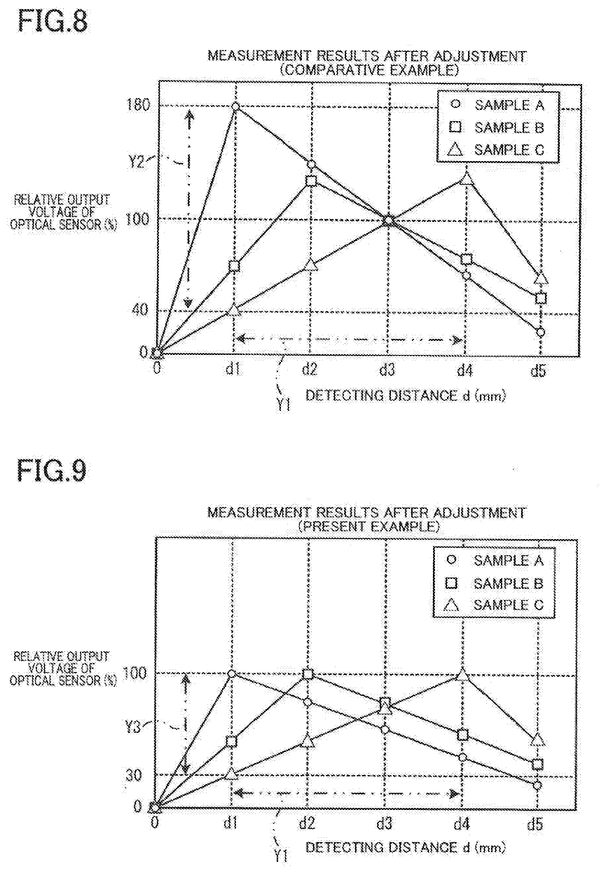

Referring to FIGS. 8 and 9, there will be explained results of measurement of a relative output voltage of the optical sensor 30 with respect to the detecting distance d in the printer 1 in which the output voltage of the optical sensor 30 has been adjusted. In a comparative example of FIG. 8, the output voltage of the optical sensor 30 is adjusted in a way different from that of the present embodiment. Specifically, the output voltage of the optical sensor 30 is adjusted in a state in which the optical sensor 30 is installed on the printer 1, such that the output voltage of the optical sensor 30 at the reference detecting distance D (the detecting distance d3) is equal to a value indicative of a predetermined certain voltage. This value will be hereinafter referred to as “set value” where appropriate. In other words, in the comparative example, the output voltage of the optical sensor 30 is adjusted such that the output voltage of the optical sensor 30 at the reference detecting distance D becomes equal to the set value, irrespective of the output characteristic of the optical sensor 30. The graph of FIG. 8 according to the comparative example shows measurement results of the relative output voltage of the optical sensor 30 in the printer 1 in which the output voltage is thus adjusted. The graph of FIG. 9 according to a present example shows results of measurement of a relative output voltage of the optical sensor 30 in the printer 1 in which the output voltage is adjusted according to the sensor-output adjusting method of the present embodiment. In the comparative example of FIG. 8, the relative output voltage of the optical sensor 30 is shown in an instance where 0 V is defined as 0% and the output voltage of the optical sensor 30 at the reference detecting distance D (the detecting distance d3) is defined as 100%. In the present example of FIG. 9, the relative output voltage of the optical sensor 30 is shown in an instance where 0 V is defined as 0% and the working-voltage upper limit value is defined as 100%.

While the printing tape 10 is being conveyed in the printer 1, the printing tape 10 may shift or move, with respect to the conveyance path 22 in design, in a direction in which the printing tape 10 is opposed to the optical sensor 30 due to slack of the printing tape 10, for instance. In this case, the detecting distance d changes. Assume that the detecting distance d changes within a range of d1-d4 (as indicated by arrows Y1 in FIGS. 8 and 9). In the comparative example of FIG. 8, the relative output voltages of the optical sensors 30, i.e., the sample optical sensors A-C, vary in a range of 40%-180% (as indicated by the arrow Y2 in FIG. 8). In the present example of FIG. 9, in contrast, the relative output voltages of all of the optical sensors 30, i.e., all of the sample optical sensors A-C, at the peak detecting distance are 100%. Thus, in the present example, the relative output voltages vary in a range of 30%-100% (as indicated by the arrow Y3 in FIG. 9). As apparent from the graphs of FIGS. 8 and 9, the variation in the relative output voltage among the optical sensors 30 in the present example of FIG. 9 (corresponding to the range indicated by the arrow Y3) is smaller than the variation in the relative output voltage among the optical sensors 30 in the comparative example of FIG. 8 (corresponding to the range indicated by the arrow Y2). That is, the variation in the relative output voltage among the optical sensors 30 with respect to the variation or change in the detecting distance d can be prevented or reduced by adjusting the sensor output voltage according to the method of the present embodiment.

In the comparative example of FIG. 8, the set value needs to be determined beforehand such that the output voltage when the relative output voltage is 180% is equal to the working-voltage upper limit value so as to prevent the output voltage of the optical sensors 30 from exceeding the working-voltage upper limit value. In the comparative example, because the variation in the relative output voltage among the optical sensors 30 with respect to the detecting distance d (corresponding to the range indicated by the arrow Y2 in FIG. 8) is large, it is difficult for designers to widen a reference range of the output voltage set for the optical sensors 30 (i.e., a range of the output voltage of the optical sensors 30 from a lower limit value to the set value). In the present embodiment, in contrast, because the variation in the relative output voltage among the optical sensors 30 is small, the designers can widen the reference range of the output voltage set for the optical sensors 30 (i.e., a range of the output voltage of the optical sensors 30 from a lower limit value to the target value).

Hereinafter, the sample optical sensor A and the sample optical sensor C in each of which the output voltage is adjusted according to the adjusting method of the present embodiment will be respectively referred to as “present sample A” and “present sample C”. On the other hand, the sample optical sensor A and the sample optical sensor C in each of which the output voltage is adjusted according to the adjusting method of the comparative example will be respectively referred to as “comparative sample A” and “comparative sample C”.

As mentioned above, the reflectivity of the identification marks 11 is smaller than the reflectivity of the mark-non-printed portions 12 in the present embodiment. Thus, the output voltage of one optical sensor 30 when the one optical sensor 30 detects the mark-non-printed portion 12 is larger than the output voltage when the one optical sensor 30 detects the identification mark 11. In the case where the identification mark 11 and the mark-non-printed portion 12 are detected by mutually different optical sensors 30, it is highly likely that the output voltage when the comparative sample A detects the identification mark 11 becomes higher than the output voltage when the comparative sample C detects the mark-non-printed portion 12, as the reference range of the output voltage set for the optical sensors 30 becomes narrower. In other words, the upper limit of the mark detecting range inevitably needs to be made larger than the lower limit of the mark-non-printed-portion detecting range, undesirably leading to the possibility of overlapping of the mark detecting range and the mark-non-printed-portion detecting range.

If the mark detecting range and the mark-non-printed-portion detecting range overlap, the CPU 71 finds difficulty in determining whether the identification mark 11 is detected or whether the mark-non-printed portion 12 is detected. In the printer 1 of the present embodiment, in contrast, the reference range of the output voltage set for the optical sensors 30 can be widened, thus reducing the possibility that the output voltage when the present sample A detects the identification mark 11 becomes higher than the output voltage when the present sample C detects the mark-non-printed portion 12. In other words, the present printer 1 can reduce the possibility of overlapping of the mark detecting range and the mark-non-printed-portion detecting range due to the upper limit of the mark detecting range that becomes larger than the lower limit of the mark-non-printed-portion detecting range. Thus, the present printer 1 can reduce erroneous detection of the identification mark 11 and the mark-non-printed portion 12 by the CPU 71, thus making it possible to enhance the detection accuracy of the optical sensor 30. This configuration leads to an increase in the types of the identification mark 11 identifiable by the optical sensor 30, so that the increased number of types of the printing tape 10 are available in the printer 1.

According to the sensor-output adjusting method explained above, the output voltage of the optical sensor 30 is adjusted in the adjusting step based on the adjustment information. The adjustment information is information that is based on the correction value, and the correction value is a value corresponding to the output characteristic unique to the optical sensor 30. Thus, the variation in the output voltage among the optical sensors 30 is prevented or reduced. Accordingly, in the printer 1 on which is installed the optical sensor 30 whose output voltage has been adjusted, the detection accuracy of the optical sensor 30 is high. This configuration leads to an increase in the types of the identification mark 11 identifiable by the optical sensor 30, so that the increased number of types of the printing tape 10 are available in the printer 1.

In the adjusting step, the output voltage of the optical sensor 30 is adjusted with the peak value and the reference value taken into consideration. Thus, the printer 1 on which is installed the optical sensor 30 whose output voltage has been adjusted is less likely to suffer from the variation in the output voltage of the optical sensor 30 with respect to the variation in the detecting distance d between the optical sensor 30 and the printing tape 10. Accordingly, in the printer 1 on which is installed the optical sensor 30 whose output voltage has been adjusted, the detection accuracy of the optical sensor 30 is high. This configuration leads to an increase in the types of the identification mark 11 identifiable by the optical sensor 30, so that the increased number of types of the printing tape 10 are available in the printer 1.

The target value is calculated after the adjustment information has been acquired in the acquiring step. Accordingly, even in the case where the optical sensors 30 are installed on the printers 1 in different models, in other words, even in the case where the working-voltage upper limit value differs depending on the model of the printer 1, the output voltage of the optical sensor 30 in each printer 1 can be adjusted to the target value appropriate for the model of the printer 1.

The output voltage of the optical sensor 30 is adjusted in the adjusting step with the working-voltage upper limit value further taken into consideration, in addition to the peak value and the reference value. Thus, the printer 1 on which is installed the optical sensor 30 whose output voltage has been adjusted is less likely to suffer from the variation in the output voltage of the optical sensor 30 with respect to the variation in the detecting distance d between the optical sensor 30 and the printing tape 10. Accordingly, in the printer 1 on which is installed the optical sensor 30 whose output voltage has been adjusted, the detection accuracy of the optical sensor 30 is high. This configuration leads to an increase in the types of the identification mark 11 identifiable by the optical sensor 30, so that the increased number of types of the printing tape 10 are available in the printer 1.

In the present embodiment, the printing tape 10 corresponds to “medium”. The identification mark 11 corresponds to “mark”. S2 corresponds to “first calculating step”. S3 corresponds to “recording step”. S5 corresponds to “acquiring step”. S7 corresponds to “adjusting step”. The peak value corresponds to “first value”. The reference value corresponds to “second value”. The working-voltage upper limit value corresponds to “upper limit value”. S6 corresponds to “second calculating step”. The portion of the CPU 71 that executes S11 corresponds to “acquirer”. The portion of the CPU 71 that executes S13-S17 corresponds to “adjuster”.

The present disclosure may be otherwise embodied. For instance, the target value may be calculated before the recording step (S3), based on the correction value calculated in the first calculating step. This step of calculating the target value corresponds to “third calculating step”. The third calculating step is one example of a third determining step of determining, based on the correction value determined in the first determining step, the target value that the output value required to be output with the optical sensor 30 when the optical sensor 30 detects the detection target at the reference detecting distance. In this case, the adjustment information indicative of the target value is recorded on the record carrier 49 so as to be associated with the optical sensor 30 in the recording step, and the second calculating step is omitted. Thereafter, in the adjusting step (S7), the output voltage of the optical sensor 30 is adjusted so as to become equal to the target value indicated by the adjustment information acquired in the acquiring step (S5). In this case, because the target value is calculated before the adjustment information is recorded in the recording step, it is not needed to calculate the target value based on the adjustment information after the adjustment information is acquired in the acquiring step. Further, the PC 45 calculates the target value according to the above equation (1) in this case, thus preventing an increase in memory capacity of the ROM 72. For changing the working-voltage upper limit value in this case, the working-voltage upper limit value stored in the memory of the PC 45 may be changed, thus eliminating the need to change, in each printer 1, the working-voltage upper limit value stored in the ROM 72.

In place of the third calculating step described above, there may be implemented, as the third determining step, a step of determining the target value by referring to a table or the like, for instance.

In the illustrated embodiment, the bar code is printed on the record carrier 49. A QR code (registered trademark) or the like may be printed on the record carrier 49. On the record carrier 49, there may be printed a link or the like in which the adjustment information and the unique information are stored. The record carrier 49 may be a storage device. The storage device may be provided on the board on which the optical sensor 30 is mounted. The record carrier 49 may be provided on the control board 70, in other words, the flash memory 74 may function as the record carrier 49, for instance. In this case, the CPU 71 stores the adjustment information in the flash memory 74 in the recording step and acquires the adjustment information from the flash memory 74 in the acquiring step. In place of the reading device 38, an analog-to-digital converter (ADC) may be provided, and the CPU 71 may acquire the adjustment information via the ADC.

A position sensor for detecting the position of the jig 42 may be used in the measuring step, and the PC 45 may detect the detecting distances d based on detection signals from the position sensor. An ultrasonic sensor or the like that can identify the detecting distances d may be used in the measuring step, and the PC 45 may obtain the detecting distances d based on detection signals from the ultrasonic sensor or the like. An encoder-equipped motor for moving the jig 42 may be used in the measuring step, and the PC 45 may obtain the detecting distances d based on signals from the encoder. The detecting distances d may be predetermined values, and the PC 45 may obtain the detecting distances d from its memory.

The method of adjusting the output of the optical sensor 30 employed in the adjusting step is not limited to that described in the illustrated embodiment. In the illustrated embodiment, the detected voltage is adjusted so as to become equal to the target value by gradually increasing the light emission amount of the light emitting portion 31. The detected voltage may be adjusted so as to become equal to the target value by gradually decreasing the light emission amount of the light emitting portion 31. In this case, the light emission amount of the light emitting portion 31 may be set to an upper limit value at S13. The detected voltage may be adjusted so as to become equal to the target value by determining the light emission amount of the light emitting portion 31 that is to be next set, based on the light emission amount that has been previously set and the detected voltage that corresponds to the previously set light emission amount. The detected voltage may be adjusted so as to become equal to the target value by changing the light receiving amount of the light receiving portion 32. The detected voltage may be adjusted so as to become equal to the target value by changing both the light emission amount of the light emitting portion 31 and the light receiving amount of the light receiving portion 32.

In FIG. 6, the number of the detecting distances d for each of which the output voltage is measured is the same among the three samples, i.e., the sample optical sensor A, the sample optical sensor B, and the sample optical sensor C. The number of the detecting distances d may be made different among samples. In FIG. 6, the output voltage of the optical sensor 30 is measured at the reference detecting distance D, namely, at the detecting distance d3, as the detecting distance d, to obtain the reference value. The output voltage of the optical sensor 30 does not necessarily have to be measured at the reference detecting distance D to obtain the reference value. For instance, the reference value may be calculated based on the measurement values using a calculating formula for calculating the reference value. Similarly, the peak value may be calculated based on the measurement values using a calculating formula for calculating the peak value. The method of identifying the peak value and the reference value is not limited to that in the illustrated embodiment. The peak value and the reference value may be estimated.

The series of steps of the sensor-output adjusting method, i.e., the measuring step (S1), the first calculating step (S2), the recording step (S3), the installing step (S4), the acquiring step (S5), the second calculating step (S6), and the adjusting step (S7), may be performed in a working process continuously performed or may be performed in a plurality of working processes intermittently performed. In the adjusting step, the PC 45 may be connected to the printer 1 via the external interface 37. In this case, the PC 45 may execute the sensor-output adjusting processing. The optical sensor 30 may be of a transmission type. In this case, the light emitting portion 31 and the light receiving portion 32 are disposed so as to be opposed to each other with the conveyance path 22 interposed therebetween. In the illustrated embodiment, the light emitting portion 31 of the optical sensor 30 emits the light toward the printing tape 10 in the adjusting step. In place of the printing tape 10, a medium having a surface formed of the same material as the reference surface 41 may be used, and the light emitting portion 31 of the optical sensor 30 may emit the light toward the surface. In the illustrated embodiment, the plurality of identification marks 11 are printed on the printing tape 10. Only one identification mark may be printed on the printing tape 10. The shape of the identification marks 11 is not limited to the rectangular shape shown in FIG. 1. The identification marks 11 need not be printed but may be in the form of through-holes, for instance. The identification marks 11 do not necessarily have to be provided on the printing tape 10. In this case, the optical sensor 30 may be configured to detect the printing tape 10 itself.

In the illustrated embodiment, the reference range of the output voltage set for the optical sensors 30 is determined by taking account of only the variation in the voltage output characteristic among the optical sensors 30 with respect to the detecting distance d. In addition, variations due to other factors may be taken into account, such as a variation due to an ambient light, a variation in the voltage output characteristic among the optical sensors 30 with respect to a temperature, a variation due to a pulse-width modulation (PWM) adjustment, a variation due to aged deterioration of the optical sensors 30, and a variation in the reflectivity of the printing tape 10.

What is claimed is:

1. A method of adjusting an output of a sensor in a printer, the sensor being configured to detect a detection target that is one of a medium itself and a mark attached to the medium, the method comprising:
a first determining step of determining a correction value corresponding to an output characteristic unique to the sensor;
a recording step of recording, on a record carrier, adjustment information that is based on the correction value determined in the first determining step, such that the adjustment information is associated with a specific sensor that is the sensor for which the correction value is determined in the first determining step;
an acquiring step of acquiring, from the record carrier, the adjustment information associated with the specific sensor; and
an adjusting step of adjusting, in the printer on which the specific sensor is installed, an output of the specific sensor based on the adjustment information acquired in the acquiring step.

2. The method according to claim 1,
wherein the sensor is an optical sensor including a light emitter and a light receiver,
wherein the method further comprises a measuring step in which a reference surface is irradiated with light emitted from the light emitter and reflected light from the reference surface is detected with the light receiver, so as to obtain measurement values each indicative of an output of the optical sensor at a corresponding one of at least two mutually different detecting distances each of which is a distance between the optical sensor and the reference surface, the measuring step being performed prior to the first determining step, and
wherein, in the first determining step,
i) a first value indicative of a peak of the output of the optical sensor and a second value indicative of the output of the optical sensor at a reference detecting distance that is a distance between the detection target and the optical sensor installed on the printer are identified based on the measurement values obtained in the measuring step, and
ii) the correction value is determined based on the identified first value and the identified second value.

3. The method according to claim 2,
wherein, in the recording step, the adjustment information indicative of the correction value determined in the first determining step is recorded on the record carrier so as to be associated with the specific sensor,
wherein the method further comprises a second determining step of determining, based on the correction value indicated by the adjustment information acquired in the acquiring step, a target value that is an output value required to be output with the optical sensor when the optical sensor detects the detection target at the reference detecting distance, and
wherein, in the adjusting step, the output of the specific sensor at the reference detecting distance is adjusted so as to become equal to the target value determined in the second determining step.

4. The method according to claim 2, further comprising a third determining step of determining, based on the correction value determined in the first determining step, a target value that is an output value required to be output with the optical sensor when the optical sensor detects the detection target at the reference detecting distance,
wherein, in the recording step, the adjustment information indicative of the target value determined in the third determining step is recorded on the record carrier so as to be associated with the specific sensor, and
wherein, in the adjusting step, the output of the specific sensor at the reference detecting distance is adjusted so as to become equal to the target value indicated by the adjustment information acquired in the acquiring step.

5. The method according to claim 3,
wherein the correction value is a ratio of the second value to the first value, and
wherein the target value is obtained by multiplying the correction value by a predetermined upper limit value of the output of the optical sensor.

6. The method according to claim 4,
wherein the correction value is a ratio of the second value to the first value, and
wherein the target value is obtained by multiplying the correction value by a predetermined upper limit value of the output of the optical sensor.

7. The method according to claim 1, wherein the first determining step is a step of determining the correction value before the sensor is installed on the printer.

8. The method according to claim 1, wherein the record carrier is a tape on which is printed a bar code indicating the adjustment information.

9. The method according to claim 1, wherein the record carrier is a tape on which is printed a QR code indicating the adjustment information.

10. A printer, comprising:
a sensor configured to detect a detection target that is one of a medium itself and a mark attached to the medium;
an acquirer configured to acquire, from a record carrier, adjustment information that is based on a correction value corresponding to an output characteristic unique to the sensor; and
an adjuster configured to adjust an output of the sensor based on the adjustment information acquired by the acquirer.
